(19) United States
(12) Patent Application Publication
(10) Pub. No.: US 2016/0267585 A1
(43) Pub. Date: Sep. 15, 2016

(54) Method for converting long term debt debt of commercial borrowers into receivables

(71) Applicant: Svetoslav Lazarov Gramenov, Varna (BG)

(72) Inventor: Svetoslav Lazarov Gramenov, Varna (BG)

(21) Appl. No.: 14/656,750

(22) Filed: Mar. 13, 2015

(51) Int. Cl. G06Q 40/02; G06Q 20/38

(52) U.S. Cl. CPC G06Q 40/025; G06Q 20/381

(57) ABSTRACT

The invention provides a method for lending/borrowing in a web-based payment system with a multitude of currencies, where a public currency serves as a universally accepted medium of exchange, while private currencies, issued by commercial entities—represent obligations of the issuers to provide certain amounts of goods and services. When a potential commercial borrower wants to receive a loan, the centralized authority (the lender) issues, against collateral, a certain amount of new, public, universally accepted currency units into the borrower's account. The borrower issues to the centralized authority an equivalent amount of his private units plus the agreed upon units of interest, which units mature (get activated) gradually over time, at each loan repayment due date. Upon maturity a unit of the matured private, commercial currency can be redeemed by the lender for goods and services of the borrower, or just released into circulation within the money system.

### BACKGROUND

1. Field of Invention

The current disclosure relates generally to long term lending against collateral in a virtual lending system where borrowers are obliged to make good on their debts with real output of goods and services at loan maturity dates.

2. Description of the Related Art

Currently, credit (so called “bank money”) is created by commercial banks as debt, against interest, in the process of fractional reserve banking. Since money for the interest is not created, there is a built-in growth requirement for the economy which is using the current system of money and banking, as interest for the debts must be acquired from other borrowers, hence the necessity for ever-larger borrowing—a requirement that may eventually be bounded by the finite resources of the planet. Moreover, since new money via lending can be issued for speculation, this causes self-fulfilling asset-price bubbles in the economy, and when the bubbles burst, the previously inflated asset prices are destroyed, while the debts incurred to acquire the assets are not. The shrinking of bank balance sheets in a recession/depression after a bubble bursts slows down creation of new money for productive activities, hurts the economy, and often requires government interference (so called “Keynesianism”) in order to bring the economy back to full or near-full employment levels. There are limits to Keynesian interventions, though, as in the long run they lead to depreciating fiat currency and overleveraged governments.

A partial solution to the fractional reserve lending practices is offered by systems with credit-union or crowd-funding (peer-to-peer) lending solutions. This type of lending does not increase the money supply because users are not entitled to create new money the way banks are. However, in order for a lender to extend a loan he must first have in possession the respective amount of money. This creates a problem for bigger companies with larger capital needs.

Alternative monetary systems which use a medium of exchange different from common fiat money may offer various lending opportunities. Perhaps the most convenient solution for lending is implemented in mutual credit systems, also known as LETS (local exchange trading system) schemes. In LETS schemes all users who join the system have an initial balance of their account of 0. If they want to purchase goods and services from other users their account is just credited with the respective amount and it becomes a negative value. This means that the user has taken credit from the rest of the users of the system and in order for his balance to reach a positive value he must sell his own goods and services so that his account gets debited. LETS schemes solve the problem with money supply but still borrowers are supposed to sell their goods and services and repay the loan with money, not to mention the severe limitation of the scope of virtually all LETS schemes.

Currently no convenient lending solution exists for businesses, which does not rely on the flawed fractional reserve banking process.

### US Patent Documents:

Application Ser. No. 13/412,758, filed Sep. 12, 2013;

Application Ser. No. 14/284,925, filed May 22, 2014;

Application Ser. No. 12/210,903, filed Sep. 15, 2008

### SUMMARY

This section explains how the invention overcomes the problems pointed out in the background. A method for long term lending is provided in a network-based payment system where long term debt of borrowers converts into money (obligations of the borrower to provide real output) at loan due dates, which obligations can either be redeemed with the borrower for the borrower's output of goods and services or released into circulation in the economy.

The system in which the method can be implemented connects users with a server which executes transactions and manages user accounts in a central database. Each borrower is obligated to provide enough information in order to be identified as a person or a legal entity in real economy. Users of the system have digital accounts recorded in the database where their currency is stored and managed. Each user can have multiple accounts with different type of currency units in them. Accounts are stored in user wallets.

User accounts are used to perform transactions in the system. The accounts are complex data structures which include at least the amount of currency units in the account. Some accounts have an additional field—issuer of the currencies. This data refers to the user for whose goods and services the currency units in the respective account can be redeemed. Furthermore a third type of account contains yet another parameter—maturity date. Maturity rate represents a future moment in time when currency units will become available to be redeemed for goods and services of the issuer.

When a lender and a borrower agree on the terms of a loan contract the server performs two tasks. Initially the respective account of the borrower is credited with the amount. The server also creates a new account in the wallet of the lender and credits it with the agreed amount of currency units plus agreed upon interest, which currency units can be redeemed for goods and services of the borrower at pre-set loan repayment dates. When any of these currency units are transacted to the borrower for redemption with the borrower's goods and services, they are extinguished.

This method of lending gives businesses the opportunity to repay their debt not with money but with goods and services. A loan no longer represents the obligation of the borrower to repay a certain amount of money.

### BRIEF DESCRIPTION OF DRAWINGS

FIG. 1 illustrates the basic characteristics of three different types of currency units used in the method.

FIG. 2 represents the way the method is executed in a payment system and the interactions between the different users.

FIG. 3 shows the basic steps in the method through a flowchart.

FIGS. 4.1, 4.2 and 4.3 illustrate the transactions in the payments system as executed by the server.

FIG. 5 represents the maturity process for the long term debt and how it is executed by the server.

### DETAILED DESCRIPTION

An exemplary embodiment, as described below, may be used to provide a method for creating long term credit in a network based payment system and converting it to receivables for real wealth—goods and services.

### Currency Pattern

Long term debt in the payment system is created, transacted and repaid through various currencies, generated either on the initiative of the users or by a central authority. Currency, issued by the central authority will be hereinafter referred to as “public” currency. Currency issued on the initiative of the users on the other hand will be referred to as “private” currency. Private currencies are always backed by the obligation of users on whose initiative they have been created to provide a certain amount of goods and services which they offer in the real economy. Long term lending is facilitated through the use of these currencies as will be further explained in the current specification. There are two basic types of private currencies —idle and mature. Idle currencies represent receivables for goods and services of the issuer which cannot be redeemed at the present moment but will be redeemable at a predefined future moment in time. Maturing (active) currencies represent receivables that can presently be redeemed for goods and services.

Currencies and currency units are created and transacted by a server, coupled to a database and connected to the users of the system through a network. Instead of a single server a multitude of servers grouped together can also be used to operate the system. The database is used for storing data about users of the system and the currency the have. Users communicate with the server through data processing devices capable of sending and receiving data over the network and visualizing an interface for user interaction with the system through software installed on the device. These devices may be personal computers, laptops, smart phones, tablets or any other similar device.

For each user of the payment system the server creates a wallet in the database. The wallet represents a separate piece of memory in the database for storing data about the identity of a user and the type and amount of currency that he has. Currency is managed through accounts. Accounts are complex data structure recorded in the wallets of the users. Each account represents a specific type of currency held by a certain user.

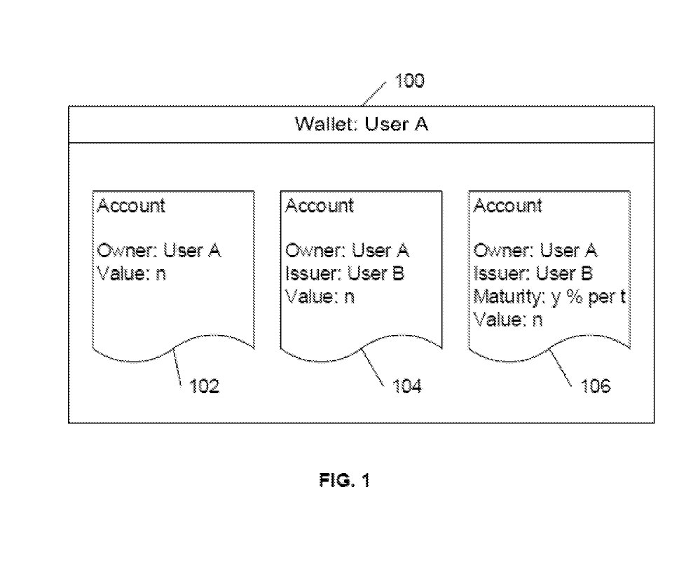

The structures of the three main types of currencies will be explained with reference to FIG. 1. A user wallet (100), being a separate piece of memory in the database is illustrated with three accounts recorded in it. The first account (102) only has two parameters—owner and value. The value parameter is a number which indicates the amount of currency in the account, or more simply put how much currency units it contains. This account only contains units of the public currency. The next account (104) is used for keeping record of the amount of units of a specific mature private currency. In addition to the value and owner parameter this account also has an issuer parameter which indicated the user for whose goods and services the currency can be redeemed in the real economy. The last account illustrated (106) is used for keeping record of the amount of units of a specific idle private currency. It has the three parameters of the mature private currency account (104) but also has a maturity parameter which indicates the rate at which the currency matures.

Interaction between Users in the Context of Long Term Debt

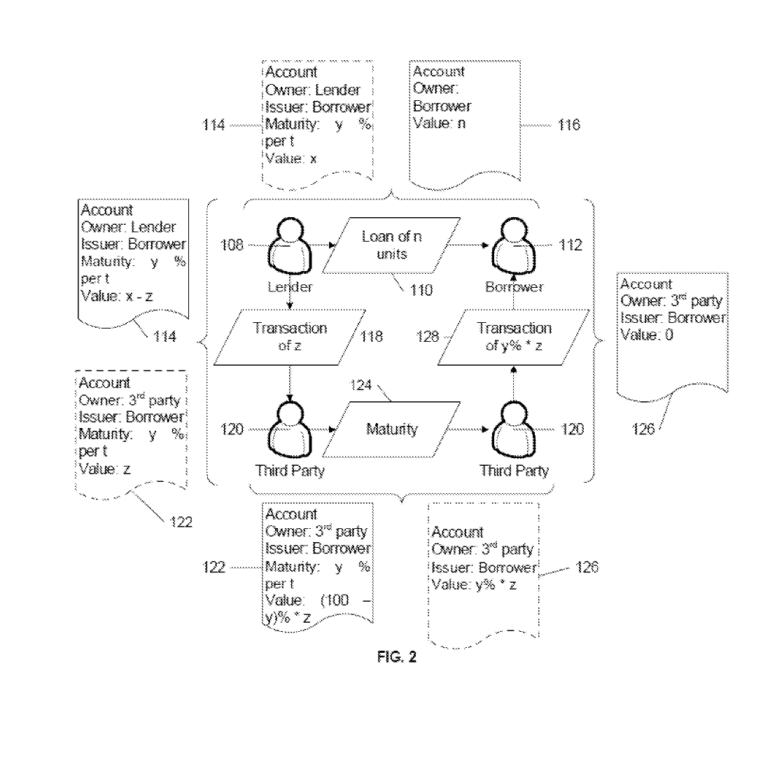

The interaction between the users of the system in the context of long term debt will be explained with reference to FIG. 2. The users depicted in FIG. 2 act as lender (108), borrower (112) and a third party (120).

In order for a long term debt to be created at first a user acting as a lender (108) must transfer a certain amount of currency units to another user, acting as a borrower (112). In FIG. 2 the lender transfers an amount of newly created public currency units (110) form his account to the account of the borrower (116). In order to execute a long term debt transaction the server must receive two requests—a transaction request from the lender and an issuance request from the borrower. Thus upon receiving the said requests the server credits the public currency account of the borrower with the said amount of currency units. The server simultaneously creates a new account in the wallet of the lender for storing an x amount of idle private currency units issued by the borrower (114). The amount and maturity dates are agreed by the lender and the borrower and are included in the issuance request, handled by the server.

During the next step in the process the lender transacts an y amount of the idle private currency, issued by the borrower (118), to a third party (120). Upon receiving a transaction request the server debits the account of the lender (114) which stores idle private currency units issued by the borrower and creates a respective account in the wallet of the third party (122). The account of the lender is debited by decreasing the value with the amount transferred to the third party. The value parameter if the lender account is now equals x−z.

FIG. 2 also illustrates the maturity process of the private currencies. Upon maturity a certain part of the currency units in an idle private currency account are converted into mature private currency units. This process repeats over time until all of the currency units in an idle private currency account are converted to mature currency units. During this process the owner of the currency is not changed. Two parameters determine the maturity rate—maturity period t and maturity percentage y. This means that when a t period of time expires after the issuance an y percent of the idle currency units in an account will be converted to mature currency units. The process will then be repeated again and again until all the units are converted to mature. Upon maturity at a moment t the server automatically decreases the value z of the account of the user (122) which has a certain amount of idle currency stored and the new value parameter of this account now equals (100−y) percent of z. The server also creates a new account in the wallet of the user (126) for storing the converted mature currency units. The value parameter of this account equals y percent of z. If such account already exists the server will increase its value parameter with the respective amount of currency units.

The last step of the process is the extinguishments of the mature private currency units upon transaction to the borrower. This sub-process implies that when mature currency is transferred to its issuer it is extinguished. The third party (120) who has a y percent of z amount of mature currency units issued by the borrower transfers them to the borrower (128). The server than decreases the value parameter of the respective account of the third party (126) but does not create an account in the wallet of the borrower for storing the amount of currency units transferred. Thus these currency units are extinguished from the system.

FIG. 2 represents the full turnover of private currency units issued as long term debt. A borrower basically repays his debt not with currency but with the goods and services he provides to society. Money issued in this way can circulate freely among the users of the system until they are transferred to the user upon whose request it has been issued.

### The Method as a Flow Chart

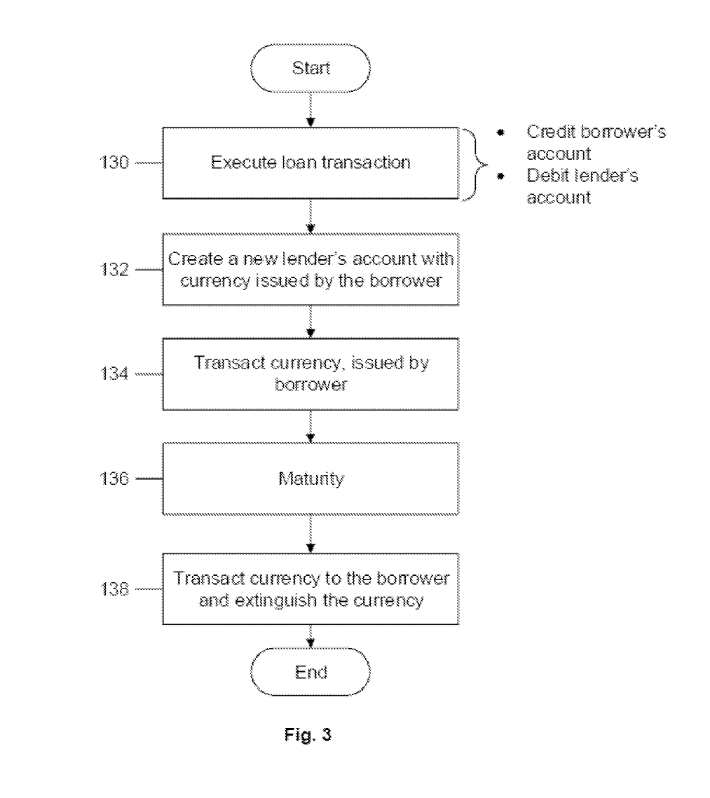

The process of the method is illustrated as a flow chart in FIG. 3. Five basic steps are depicted. At first a loan transaction must be executed (130). The server transfers some newly created units from the lender to the borrower. After that new idle private currency units are created. The server creates an account for storing them at the wallet of the lender (132). These currency units can be transferred in the system to other users (134) even before they are converted to mature. Upon maturity (136) a predefined amount of the idle currency units is converted to mature which are also available for transactions. When any of the mature currency units are transferred to the borrower for redemption through his goods and services, they are extinguished (138). It is important to note that idle currency units can also be transferred to the user under whose initiative they have been created. These currency units will not be extinguished immediately but if not transferred to another user will extinguish upon maturity.

### Transactions

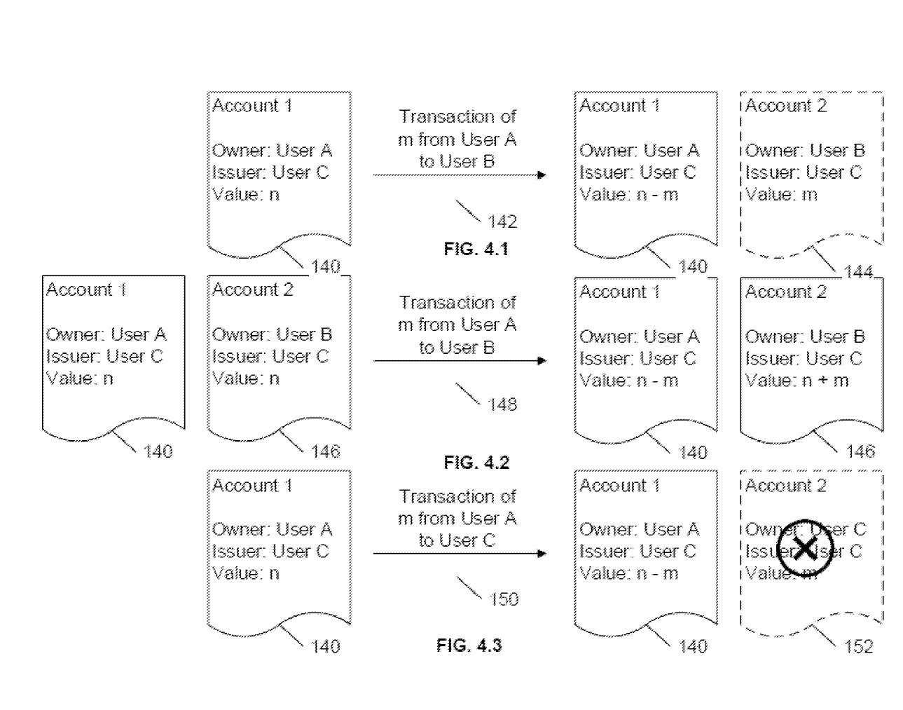

Transactions in the system with mature private currency units will be explained in detail with reference to FIG. 4.1, FIG. 4.2 and FIG. 4.3. FIG. 4.1 illustrates a transaction of m currency units (142) to a user who receives such units for the first time and thus there is no account for storing such currency units in his wallet. The payee is also not the user upon whose initiative the currency units have been created. In order to execute the transaction the server must decrease the value parameter of the account of the payer (140) with the amount of the transaction. The server simultaneously creates an account (144) in the wallet of the payee with the respective parameters. The account has owner parameter, issuer parameter and value parameter. The owner parameter is set to the payee, the issuer parameter is set to the issuer of the currency and the value equals the amount of the transaction.

FIG. 4.2 illustrates a transaction of m currency units (148) to a payee who already has an account (146) for storing such currency units. The server must only alter the value parameters of the two accounts. The value of the payer's account (140) is decreased with the amount of the transaction and the value of the payee's account is increased respectively.

Finally FIG. 4.3 illustrates the process of money extinguishment upon transaction to the issuer (150). In order to execute such transaction the server must only decrease the value parameter of the account of the payer (140) with the amount of the transaction. No account is created in the wallet of the payee (152) since he is also the issuer of the currency.

Upon executing a transaction with mature private currency unit the server must first check is the payee is the issuer of the currency. It extracts the issuer parameter data of the respective account of the payer and compares it to the payee. If the payee is different than the issuer the server must check if there is already an account for storing the type of quants transferred in the wallet of the payee. If such account exists the server will only increase its value parameter. If not, the server must first create such account in the database.

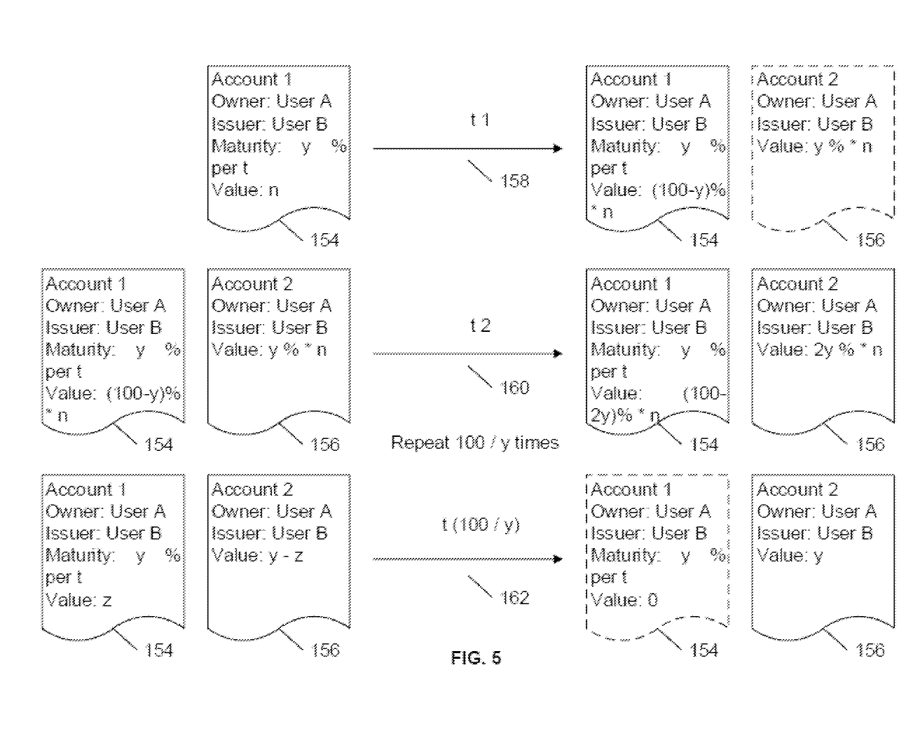

The maturity process for private currencies will be explained with reference to FIG. 5. An example account (154) is illustrated which stores idle private currency units which mature at a certain rate, namely y percent of the initial value n of the account over a period of time t. Upon t1 (158), which is the moment when the first currency units in the account with idle quants will mature, the server creates a new account (156) in the wallet of the user for storing mature currency units and sets its value to y percent of n since this is the initial amount of currency unit which has matured. The server also decreases the value parameter of the account with idle currency units. The new value of this account equals (100−y) percent of n.

At t2 (158) another part of the idle currency units will mature. The server again decreases the value parameter of the account for idle currency with the same amount of currency units. The new value equals (100−2y) percent of n. Since there already is an account for storing mature currency units (156) the server only increases its value parameter which now equals 2y percent of n.

This process is repeated until there are no more currency units in the idle currency account. This will happen at t (100/y) rounded up to an integer. For example if the maturity rate is 3 percent per t than the currency units in the account for idle currency will be depleted at t 34 when the rest of the idle currency units will be converted to mature. At t (100/y)−1 the account with idle currency units (154) will have a value of z which is either equal to y or is less than y and the account with mature currency will have a value of y−z. At t (100/y) (162) the server will decrease the value of the account with idle currency to 0 and increase the value of the account with mature currency to y. With this the maturity process is completed.

No transactions with idle or mature currency units are depicted in FIG. 5 but the process will not change too much if transactions are executed. If a transaction is executed with the idle currency units than it is possible for more than one users to have an account for such currency units. However the part of the idle currency units that must be converted to mature is always the same regardless of the accounts in which it is stored. The server must convert idle currency units in such accounts proportional to their values. For example if account A has a value of n and account B has the value of 2n than upon maturity twice more currency units will be converted from account B than from account A but the total amount of converted currency units will stay the same regardless of whether the currency is stored in one account or a multitude of accounts.

The method described in the current specification will make it much easier for businesses to meet their long term debts obligations since a successful borrower will not be forced to sell his goods and services and use legal tender to repay the loan, but will rather have his maturing currency units become actively circulating money within the economy.

What is claimed is:

1. A method comprising:
1.1 providing, through data processing devices, a server or a multitude of servers and a database, coupled together through a network, a payment system with different type of currencies, managed by the server by manipulating data in the database;
1.2 where currency data is recorded in accounts for different currencies in the form of complex data structures, the accounts been recorded in separate pieces of memory in the database;
1.3 the accounts having the following parameters:
(1) an owner parameter which stores data for the owner of the account;
(2) an issuer parameter which stores data for the user upon whose initiative the currency has been created;
(3) a maturity date parameter which stores data for amounts of currency units in the account, which mature over a predefined period of time;
(4) value parameter which stores data for the amount of currency units in the account;
1.4 where three types of currency are available for payment in the system:
(1) public currency which only has a value and owner parameters;
(2) active (matured) private currency which has a value, owner and issuer parameter;
(3) idle private currency which has a value, owner, issuer and maturity parameter;

2. The method of claim 1 where transactions are executed upon request of a user acting as a payee by the server by decreasing the value parameter of the account of the payer and increasing the value parameter of the account of the payee;

3. The method of claim 2 where upon transaction of mature currency units to the user, upon whose initiative they have been created, the server only decreases the value parameter of the account of the payer;

4. The method of claim 1 where idle private currency is gradually converted into mature private currency by the server according to the maturity rate parameter by decreasing the value parameter of the account with idle currency and increasing the value parameter of the account with mature currency;

5. The method of claim 2 where the maturity rate is a fluctuating parameter which varies according to the real economic conditions in the payment system established through the measurement of transactions in the system.
